(19) United States
(12) Patent Application Publication
(10) Pub. No.: US 2018/0040917 A1
(43) Pub. Date: Feb. 8, 2018

(54) RECHARGEABLE LITHIUM BATTERY

(71) Applicant: Robert Bosch GmbH, Stuttgart (DE)

(72) Inventors: Holger Fink, Stuttgart (DE); Joachim Fetzer, Bad-Ditzenbach (DE); Thorsten Ochs, Farmington, MI (US); Sarmimala Hore, Stuttgart (DE)

(21) Appl. No.: 15/664,287

(22) Filed: Jul. 31, 2017

(30) Foreign Application Priority Data
Aug. 2, 2016 (DE) 10 2016 214 259.3

(51) Int. Cl. H01M 10/0585; H01M 10/6556; H01M 4/38; H01M 10/659; H01M 10/0525; H01M 10/0565

(52) U.S. Cl. CPC H01M 10/0585; H01M 10/0525; H01M 10/0565; H01M 4/382; H01M 10/659; H01M 10/6556; H01M 2300/0082

(57) ABSTRACT

A rechargeable lithium battery (28) has at least two layer cells (10) arranged on top of one another, where each layer cell (10) comprises an aluminum electrode layer (12, 12′, 12″), a cathode layer (14), a polymer electrolyte layer (16), a lithium anode layer (18) and a copper electrode layer (20, 20′, 20″) which are arranged on top of one another, wherein the copper electrode layer (20, 20′) of a layer cell (10) and the aluminum electrode layer (12, 12′) of an adjacent layer cell (10) are formed by a copper layer and an aluminum layer of a CUPAL sheet (22, 22′).

### BACKGROUND OF THE INVENTION

The invention relates to a rechargeable lithium battery and a process for producing such a rechargeable lithium battery.

Conventional liquid electrolytes cannot be used in rechargeable lithium batteries since dendrites can form on the surface of a lithium electrode during charging and these can trigger a short circuit in the rechargeable battery. Furthermore, irreversible chemical reactions can occur between the electrolyte and the lithium electrode.

These problems can be solved by means of an electrolyte based on a homogeneous polymer having a high shear modulus of more than 6 GPa. However, the development of such electrolytes is difficult since the conductivity and strength are coupled with the mobility of the polymer chains. Furthermore, such electrolytes can, owing to their materials properties, make production of a rechargeable lithium battery difficult since a plurality of layers of very different, difficult-to-process materials have to be arranged on top of one another.

US 2015/0017542 A1 relates to a lithium ion battery which has solid polymer electrodes and whose collector can comprise CUPAL material.

US 2015/0056488 A1 relates to a battery having a polymer electrolyte based on a block copolymer.

### SUMMARY OF THE INVENTION

Embodiments of the present invention can advantageously make it possible to simplify the production of a rechargeable lithium battery based on a polymer electrolyte.

One aspect of the invention relates to a rechargeable lithium battery or rechargeable lithium ion battery. The rechargeable battery can, for example, serve as energy store for an electric vehicle or a hybrid vehicle.

In one embodiment of the invention, the rechargeable lithium battery comprises at least two layer cells which are arranged on top of one another, where each layer cell comprises an aluminum electrode layer, a cathode layer, a polymer electrolyte layer, a lithium anode layer and a copper electrode layer which are arranged on top of one another in this order. The cathode layer, the electrolyte layer and the anode layer form a rechargeable battery cell which is closed off by the electrode layers. The rechargeable battery cells are configured as layers of the rechargeable lithium battery, i.e. are stacked on top of one another in the same direction in which the layers of each rechargeable battery cell are also stacked on top of one another. The polymer electrolyte layer and also the cathode layer can be based on solid bodies and thus be considered to be “dry” layers. The rechargeable lithium battery does not have to contain any liquid constituents.

Furthermore, the copper electrode layer of a layer cell and the aluminum electrode layer of an adjacent layer cell are formed by a copper layer and an aluminum layer of a CUPAL sheet. CUPAL (or copper-clad aluminum) is a composite of copper and aluminum in which a copper layer is joined to an aluminum layer over its area. This can, for example, be achieved by cold rolling.

In this way, the electrodes of adjacent layer cells are automatically joined and/or connected in series without further mechanical and/or electrical joining means being required. A rechargeable battery comprising a plurality of rechargeable battery cells can be built up; this can be produced continuously by superposition of individual layers. A large rechargeable battery can be produced without individual cells having to be separately joined to one another.

In one embodiment of the invention, the polymer electrolyte layer is produced from a block copolymer. In order to increase the shear modulus of the electrolyte layer, the polymer electrolyte layer can comprise a block polymer. The one polymer of the block polymer can provide the ionic conduction. The other polymer can provide the stiffness of the block polymer.

For example, polyethylene oxide (PEO) which has been processed together with a stiffer polymer to give a block copolymer can be used as electrolyte material.

The stiffer polymer can be, for example, polystyrene (PS). For example, polystyrene-block-polyethylene oxide (SEO) is a block copolymer of PS and PEO which can be used as block polymer electrolyte layer.

The polymer electrolyte layer, which can be considered to be a solid-state layer, can be applied as separating layer to the surface of the lithium anode layer.

As an alternative to the block copolymer, the polymer electrolyte layer can also be based only on a single polymer.

In one embodiment of the invention, the cathode layer comprises a composite of a polymer and a cathode material. The polymer can be PEO. The cathode material can comprise layered oxides, for example comprising manganese. The cathode material can be based on lithium which is, for example, present together with a further metal as oxide. For example, the cathode material can comprise lithium iron phosphate (LFP), lithium nickel cobalt oxide (NCA) and/or lithium nickel manganese oxide (NCM).

In one embodiment of the invention, part of the copper layer or the aluminum layer is removed from the CUPAL sheet in a peripheral region in order to form an electrode projecting over a side or edge of the layer cells. An intermediate tap for the rechargeable lithium battery can, for example, be connected to this electrode.

In one embodiment of the invention, part of the copper layer or the aluminum layer of the CUPAL sheet is removed in opposite peripheral regions in order to form two electrodes projecting in each case beyond one side or edge of the layer cells. Stacks of layer cells which are joined via electrodes on which the copper layer or the aluminum layer has in each case been removed at the peripheral region can be produced, as described above and below. In this way, a plurality of stacks of layer cells connected in series via CUPAL sheets can be connected in parallel to electrodes projecting beyond the edge.

In one embodiment of the invention, the rechargeable lithium battery comprises a plurality of layer cells which have a plurality of CUPAL sheets to provide a copper electrode layer of a layer cell and an aluminum electrode layer of an adjacent layer cell. It is possible for not only two but instead three, four and more layer cells to be connected in series and mechanically joined via CUPAL sheets.

In one embodiment of the invention, the rechargeable lithium battery further comprises a housing which hermetically encloses the at least two layer cells arranged on top of one another. This housing can provide electrical connections and optionally contain heat regulation for the rechargeable lithium battery.

In general, the operating temperature of the layer cells based on the abovementioned polymers and materials will be in the range from 40° C. to 85° C. It is therefore generally not necessary for the rechargeable lithium battery to be charged and discharged with a number of initial cycles in order to prepare it for later use. It can be installed in a vehicle immediately after it has been produced.

In one embodiment of the invention, the rechargeable lithium battery comprises a latent heat storage material within the housing and at least one channel for conveying a coolant through the latent heat storage material. The latent heat storage material can be, for example, paraffin. A coolant, for instance water, can, for example, flow in the channels in order to remove or introduce heat from or to the latent heat storage material. Heat from the surroundings and/or electronic components of a drive or a transformer can be stored in the latent heat storage material in order, for example, to increase the operating temperature of the rechargeable lithium battery.

In one embodiment of the invention, the rechargeable lithium battery comprises a zeolite material within the housing for heat regulation of the rechargeable lithium battery. Zeolites can remove heat by releasing moisture into the surroundings. The housing can also have a window which serves for regulating the moisture content of the zeolite material and/or which can be automatically opened and closed. For example, the atmospheric humidity of the surrounding air can be measured by means of a humidity sensor, for instance a capacitive sensor, and the window can be opened when the atmospheric humidity goes below a particular value. The same window can also be opened in order to release heat when the temperature of the rechargeable lithium battery exceeds a particular value, for instance 85° C.

A further aspect of the invention relates to a process for producing a rechargeable lithium battery, for example as described above and below. It goes without saying that features of the rechargeable lithium battery can also be features of the process, and vice versa.

In one embodiment of the invention, the process comprises:

Provision of a CUPAL sheet having a copper layer and an aluminum layer; arrangement of a lithium anode layer on the copper layer; deposition of a polymer electrolyte layer on the lithium anode layer; and fastening of a cathode layer on the aluminum layer. In this way, the layer cells can be built up successively and a rechargeable lithium battery made up of a plurality of layer cells can be produced using always the same working steps.

It is possible for individual layers to be provided as foil or sheet and then be laminated onto the appropriate layer. Furthermore, individual layers can be produced only on the appropriate layer, for example by deposition of the material of which the layer concerned consists.

In an embodiment of the invention, the lithium anode layer is laminated as lithium foil onto the copper layer. It is also possible for the lithium anode layer to be deposited on the copper layer.

In an embodiment of the invention, the cathode layer is laminated onto the aluminum layer. For example, a composite material for the cathode layer can be produced as foil and subsequently laminated onto the aluminum layer. In this way, the cathode layer as foil and the lithium anode layer as foil can be laminated simultaneously onto the aluminum layer and the copper layer. The polymer electrolyte layer can then be deposited on the lithium foil.

In one embodiment of the invention, the cathode layer is deposited on the aluminum layer. As an alternative to a prefabricated foil, the cathode layer can also be produced directly on the aluminum layer.

Ideas concerning embodiments of the present invention can, inter alia, be considered to be based on the concepts and knowledge described below.

### BRIEF DESCRIPTION OF THE DRAWINGS

Embodiments of the invention are described below with reference to the accompanying drawings; neither the drawings nor the description should be interpreted as restricting the invention.

FIG. 1 shows a schematic cross section through a layer cell from a rechargeable battery according to an embodiment of the invention.

FIG. 2 shows a schematic cross section through a rechargeable battery according to an embodiment of the invention.

FIG. 3 shows a schematic cross section through an electrode for a rechargeable battery according to an embodiment of the invention.

FIG. 4 shows a schematic cross section through a rechargeable battery according to an embodiment of the invention.

FIG. 5 shows a schematic cross section through a rechargeable battery according to an embodiment of the invention.

The figures are merely schematic and not true to scale. Identical reference numerals in the figures denote identical features or features having the same function.

### DETAILED DESCRIPTION

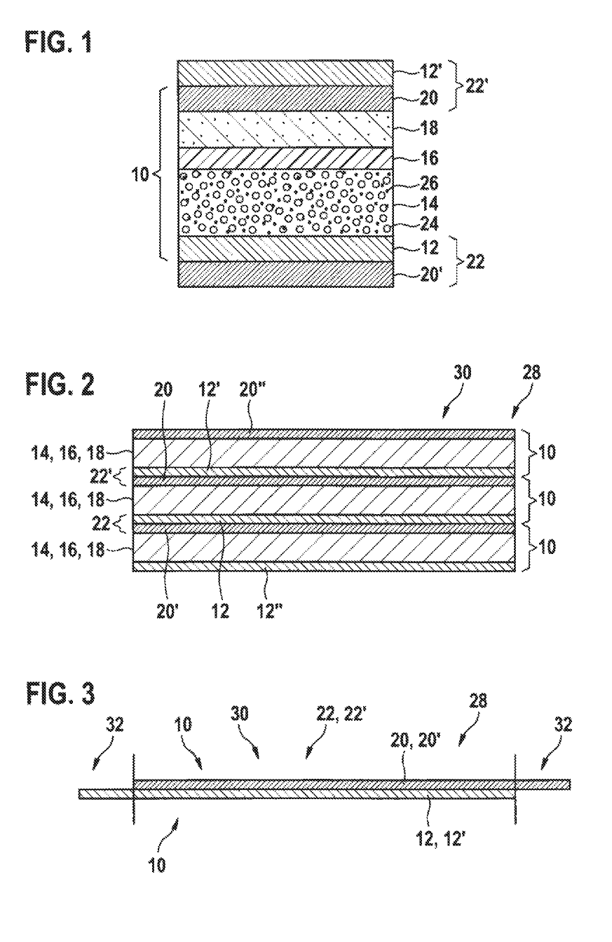

FIG. 1 shows a cross section through a layer cell 10 which has an aluminum layer 12 as electrode, a cathode layer 14, a polymer electrolyte layer 16, a lithium anode layer 18 and a copper layer 20 as further electrode.

The aluminum layer 12 is provided by a first CUPAL sheet 22 which has a further copper layer 20′. The copper layer 20 is provided by a second CUPAL sheet 22′ which has a further aluminum layer 12′.

The cathode layer 14 is a composite made up of a cathode material 24 and a polymer 26 such as polyethylene oxide (PEO). The cathode material 24 can, for example, comprise lithium iron phosphate (LFP), lithium nickel cobalt oxide (NCA) and/or lithium nickel manganese oxide (NCM).

The polymer electrolyte layer 16 is formed by a block copolymer, for instance polystyrene-block-polyethylene oxide (SEO) in which polystyrene provides the ionic conduction while the polyethylene oxide improves the mechanical properties of the polymer electrolyte layer 16.

The lithium anode layer 18 is formed by a lithium foil.

FIG. 2 shows a rechargeable lithium battery 28 which is formed by a stack 30 of a plurality of (three) layer cells 10. Adjacent layer cells 10 are in each case joined to one another by a CUPAL sheet 22, 22′. The layers 14, 16, 18 are combined in FIG. 2 for reasons of clarity. At its ends, the rechargeable lithium battery 28 can be ended by only an aluminum layer 12 or only a copper layer 20′. However, it is also possible here for further CUPAL sheets to be used as electrodes.

The rechargeable lithium battery 28 can, for example, be produced by firstly providing a CUPAL sheet 22 and laminating a lithium foil as lithium anode layer 18 onto it on the side having the aluminum layer 20.

The polymer electrolyte layer 16 can then be deposited on the lithium anode layer 18.

On the other side, a cathode layer 14 is laminated or deposited onto the CUPAL sheet 22. For example, the cathode layer 14 can be provided as foil and be laminated onto the copper layer 20′. As an alternative, the cathode layer 14 is applied from an initially still liquid material onto the copper layer 20′ and then hardens.

A plurality of these partial cells formed in this way can be arranged on top of one another in order to form the rechargeable lithium battery 28. It is also possible for, for example, further layers to be successively deposited onto the existing layers and/or be laminated onto these.

It is also possible for the rechargeable lithium battery 28 to be built up layer-by-layer proceeding from one side. For example, a cathode layer 14, a polymer electrolyte layer 16, a lithium anode layer 18 and a CUPAL sheet 22 can be laminated or deposited onto the aluminum layer 12′ (which can be provided by a CUPAL sheet). This procedure can be repeated for each of the layer cells 10.

FIG. 3 shows how an electrode formed from a CUPAL sheet 22, 22′ can be used for connecting a plurality of layer cells 10 connected in series via the CUPAL sheet 22, 22′ laterally to further layer cells 10, so that they are connected in parallel to these.

For this purpose, one of the layers 12, 12′ or 20, 20′ is removed from the CUPAL sheet 22′ at peripheral regions or edges 32 which project laterally beyond the stack 30. In this way, only an aluminum layer 12, 12′ projects out of the stack 30 on one side of the stack 30 and only a copper layer 20, 20′ projects from the stack 30 on the other side. Two or more stacks 30 can then be electrically connected to one another via these laterally projecting peripheral regions 32.

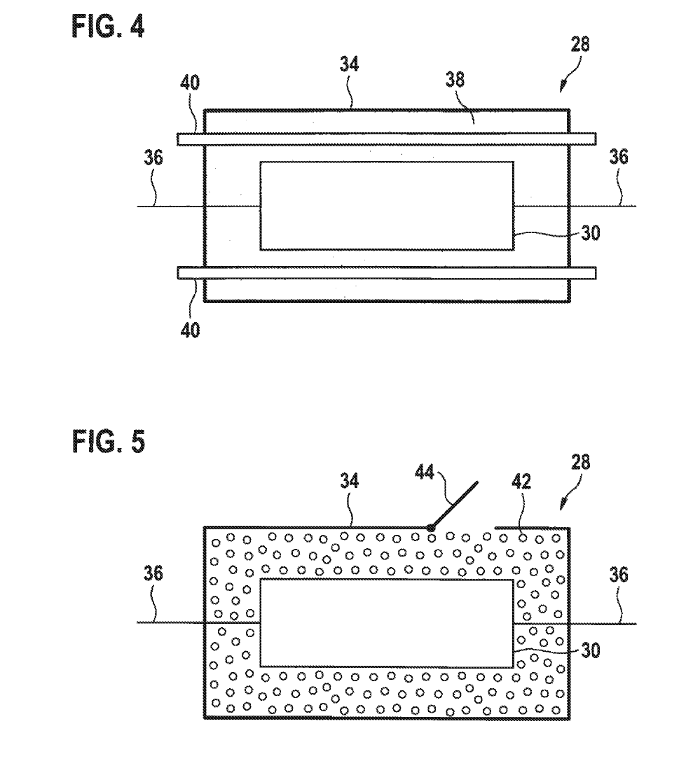

FIG. 4 shows a rechargeable lithium battery 28 in which the stack 30 made up of layer cells 10 is embedded in a housing 34 which provides, for example, the connections 36 of the rechargeable lithium battery 28.

A latent heat storage material 38, for instance paraffin, which serves to take up and release heat from the stack 30 or into the stack can be present in the housing 34. This material 38 can be cooled and/or heated by means of channels 40 in the housing 34 through which a cooling medium can be conveyed.

FIG. 5 shows that a zeolite material 42 which can be used for heat regulation of the stack 30 can also be present in the housing 34. The release and uptake of moisture from/into the interior of the housing can be controlled by means of a window 44. For example, the window can be opened when an operating temperature of the rechargeable lithium battery 28 exceeds a threshold value and/or when an ambient humidity goes below a threshold value.

In conclusion, it may be pointed out that terms such as “having”, “comprising” etc., do not exclude other elements or steps and terms such as “a” or “an” do not exclude a plurality. Reference numerals in the claims are not to be interpreted as a restriction.

What is claimed is:

1. A rechargeable lithium battery (28) comprising
at least two layer cells (10) arranged on top of one another, where each layer cell (10) comprises an aluminum electrode layer (12, 12′, 12″), a cathode layer (14), a polymer electrolyte layer (16), a lithium anode layer (18) and a copper electrode layer (20, 20′, 20″) which are arranged on top of one another,
wherein the copper electrode layer (20, 20′) of a layer cell (10) and the aluminum electrode layer (12, 12′) of an adjacent layer cell (10) are formed by a copper layer and an aluminum layer of a CUPAL sheet (22, 22′).

2. The rechargeable lithium battery (28) according to claim 1, wherein the polymer electrolyte layer (16) is produced from a block copolymer.

3. The rechargeable lithium battery (28) according to claim 1, wherein part of the copper layer (20, 20′) or the aluminum layer (12, 12′) has been removed from the CUPAL sheet (22, 22′) in a peripheral region (32) in order to form an electrode projecting beyond a side of the layer cells (10).

4. The rechargeable lithium battery (28) according to claim 1, wherein part of the copper layer (20, 20′) or the aluminum layer (12, 12′) has been removed from the CUPAL sheet (22, 22′) in opposite peripheral regions (32) in order to form two electrodes which each project beyond one side of the layer cells (10).

5. The rechargeable lithium battery (28) according to claim 1, wherein the rechargeable lithium battery (28) comprises a plurality of layer cells (10) which comprise a plurality of CUPAL sheets (22, 22′) for providing a copper electrode layer (20, 20′) of a layer cell (10) and an aluminum electrode layer (12, 12′) of an adjacent layer cell (10).

6. The rechargeable lithium battery (28) according to claim 1, which further comprises:
a housing (34) which hermetically encloses the at least two layer cells (10) arranged on top of one another;
a latent heat storage material (38) within the housing (34); and
at least one channel (40) for conveying a coolant through the latent heat storage material (38).

7. The rechargeable lithium battery (28) according to claim 1, which further comprises:
a housing (34) which hermetically encloses the at least two layer cells (10) arranged on top of one another; and
a zeolite material (42) within the housing (34) for heat regulation of the rechargeable lithium battery (28);
wherein the housing (34) comprises a window (44) for regulating the moisture content of the zeolite material (42) which can be opened and closed automatically.

8. A process for producing a rechargeable lithium battery (28), the process comprising:
providing a CUPAL sheet (22, 22′) having a copper layer (20, 20′) and an aluminum layer (12, 12′);
arranging a lithium anode layer (18) on the copper layer (20, 20′);
depositing a polymer electrolyte layer (15) on the lithium anode layer (18); and
fastening a cathode layer (14) on the aluminum layer (12, 12′).

9. The process according to claim 8, wherein the lithium anode layer (18) is laminated as lithium foil onto the copper layer (20, 20′).

10. The process according to claim 8, wherein the cathode layer (14) is laminated onto the aluminum layer (12, 12′).

11. The rechargeable lithium battery (28) according to claim 2, wherein the cathode layer (16) comprises a composite of a polymer (26) and a cathode material (24).

12. The rechargeable lithium battery (28) according to claim 1, wherein the cathode layer (16) comprises a composite of a polymer (26) and a cathode material (24).

13. The process according to claim 8, wherein the cathode layer (14) is deposited on the aluminum layer (12, 12′).
